(19) United States
(12) Patent Application Publication
(10) Pub. No.: US 2016/0191795 A1
(43) Pub. Date: Jun. 30, 2016

(54) METHOD AND SYSTEM FOR PRESENTING PANORAMIC SURROUND VIEW IN VEHICLE

(71) Applicant: Alpine Electronics, Inc., Tokyo (JP)

(72) Inventors: Maung P. Han, Torrance, CA (US); Dhruv Monga, Torrance, CA (US)

(73) Assignee: Alpine Electronics, Inc.

(21) Appl. No.: 14/585,682

(22) Filed: Dec. 30, 2014

(51) Int. Cl. H04N 5/232; G06T 7/00; G06K 9/00; H04N 5/247

(52) U.S. Cl. CPC H04N 5/23238; H04N 5/247; G06T 7/0071; G06K 9/00791

(57) ABSTRACT

A method and system of presenting a panoramic surround view in a vehicle is disclosed. Once frames are captured by a plurality of cameras for a period of time, features in consecutive frames of the plurality of cameras are detected and matched to obtain feature associations and transform is estimated based on the matched features. Based on the detected features, the feature associations and the estimated transform, a stitching region is identified. Particularly, an optical flow from the consecutive frames is estimated for the period of time and translated into a depth of an image region in the consecutive frames. Based on the depth information, a seam in the identified stitching region is estimated and the frames are stitched using the estimated seam, and presented as the panoramic surround view with priority information indicating an object of interest. In this manner, the occupant obtains an intuitive view without blind spots.

### BACKGROUND

1. Field

The present disclosure relates to a method and system for presenting panoramic surround view on a display in a vehicle. More specifically, embodiments in the present disclosure relate to a method and system for presenting panoramic surround view on a display in a vehicle such that a continuous surround display provides substantially maximum visibility with natural and prioritized view.

2. Description of the Related Art

While a driver is driving a vehicle, it is not easy for the driver to pay attention to all possible hazards in different directions surrounding the driver. Conventional multi-view systems provide wider and multiple views of such potential hazards by providing views of different angles from one or more cameras to the driver. However, the conventional systems typically provide non-integrated multiple views divided into pieces with limited visibility that are not scalable. These views are not intuitive to the driver. It is especially true when an object of the potential hazard exists in one view but is in a blind spot in the other view, even though these two views are supposed to be directed to the same region due to different points of view. Another typical confusion occurs when a panoramic view of aligning multiple views may result in showing the object of the potential hazard multiple times. While it is obvious that panoramic or surround view is desirable for the driver, poorly stitched views may cause extra stress to the driver due to the poor quality of images inducing extra cognitive load to the driver.

Accordingly, there is a need for a method and system for displaying a panoramic surround view that allows a driver to easily recognize objects surrounding the driver with a natural and intuitive view without blind spots, in order to enhance visibility of obstacles without stress due to cognitive load of surround information. To achieve this goal, there is a need for developing an intelligent stitching pipeline algorithm which functions with multiple cameras in a mobile environment.

### SUMMARY

In one aspect, a method of presenting a view to an occupant in a vehicle is provided. This method includes capturing a plurality of frames by a plurality of cameras for a period of time, detecting and matching invariant features in image regions in consecutive frames of the plurality of frames to obtain feature associations, estimating a transform based on the matched features of the plurality of cameras and a stitching region is identified based on the detected invariant features, the feature associations and the estimated transform. In particular, an optical flow is estimated from the consecutive frames captured by the plurality of cameras for the period of time and translated into a depth of an image region in consecutive frames of the plurality of cameras. A seam is estimated in the identified stitching region based on the depth information and stitching the plurality of frames is executed using the estimated seam. The stitched frames are presented as the view to the occupants in the vehicle.

In another aspect, a panoramic surround view display system is provided. The system includes a plurality of cameras, a non-transitory computer readable medium that stores computer executable programmed modules and information, at least one processor communicatively coupled with the non-transitory computer readable medium configured to obtain information and to execute the programmed modules stored therein. The plurality of cameras are configured to capture a plurality of frames by a plurality of cameras for a period of time and the plurality of frames are processed by the processor with the programmed modules. The programmed modules include a feature detection and matching module that detects features in image regions in consecutive frames of the plurality of frames and matches the features between the consecutive frames of the plurality of cameras to obtain feature associations; a transform estimation module that estimates at least one transform based on the matched features of the plurality of cameras, a stitch region identification module that identifies a stitching region based on the detected features, the feature associations and the estimated transform, a seam estimation module which estimates a seam in the identified stitching region and an image stitching module that stitches the plurality of frames using the estimated seam. Furthermore, the programmed modules include a depth analyzer that estimates an optical flow from the plurality of frames by the plurality of cameras for the period of time; and translates the optical flow into a depth of an image region in consecutive frames of the plurality of cameras so that the above seam estimation module is able to estimate the seam in the identified stitching region based on the depth information obtained by the depth analyzer. The programmed modules also include an output image processor which processes the stitched frames as the view to the occupants in the vehicle.

In one embodiment, the estimation of the optical flow can be executed densely in order to obtain fine depth information using pixel level information. In another embodiment, the estimation of the optical flow can be executed sparsely in order to obtain feature-wise depth information using features. The features may be the detected invariant features from the feature detection and matching module.

In one embodiment, object types, relative position of each object in original images, and priority information to each feature are assigned based on the depth information and the seam is computed in a manner to preserve a maximum number of priority features in the stitched view. Higher priority may be assigned to an object with a relatively larger region, an object with a rapid change of its approximate depth and size of the region indicative of approaching to the vehicle, or an object appearing in a first image captured by a first camera but not appearing in a second image captured by a second camera located next to the first camera.

In one embodiment, an object of interest in the view may be identified and a distance to the object of interest, current velocity, acceleration and projected trajectory of the vehicle are analyzed to determine whether the vehicle is in danger of an accident by recognizing the object of interest as an obstacle close to the vehicle, approaching to the vehicle, or being in a blind spot in the vehicle. Once it is determined that the object of interest is of a high risk for a potential accident of the vehicle, the object of interest can be highlighted in the view.

In one embodiment, the system may include a panoramic surround display between the front windshield and the dashboard for displaying the view from the output image processor. In another embodiment, the system may be coupled to a head up display that displays the view from the output image processor.

The above and other aspects, objects and advantages may best be understood from the following detailed discussion of the embodiments.

### BRIEF DESCRIPTION OF THE DRAWINGS

FIG. 1 is a block diagram of a system for presenting a panoramic surround view in a vehicle, according to one embodiment.

FIG. 2 is a schematic diagram of a system for presenting a panoramic surround view in a vehicle indicating a system flow, according to one embodiment.

FIGS. 3 (a) and (b) are two sample images from two neighboring cameras and their corresponding approximate depths depending on objects included in the two sample images, according to one embodiment.

FIG. 4 shows a sample synthetic image from the above two sample images of the two neighboring cameras in the vehicle, according to one embodiment.

FIG. 5 is a schematic diagram of a system for presenting a panoramic surround view in a vehicle, illustrating a first typical camera arrangement around the vehicle, according to one embodiment.

FIG. 6 is a schematic diagram of a system for presenting a panoramic surround view in a vehicle, illustrating a second typical camera arrangement around the vehicle, according to one embodiment.

FIG. 7 shows an example of a system for presenting a panoramic surround view in a vehicle, illustrating an expected panoramic view from a driver seat in the vehicle, according to one embodiment.

### DETAILED DESCRIPTION OF THE PREFERRED EMBODIMENTS

Various embodiments for the method and system of presenting panoramic surround view on a display in a vehicle will be described hereinafter with reference to the accompanying drawings. Unless defined otherwise, all technical and scientific terms used herein have the same meaning as commonly understood to one of ordinary skill in the art to which present disclosure belongs. Although the description will be made mainly for the case where the method and system method and system of presenting panoramic surround view on a display in a vehicle, any methods, devices and materials similar or equivalent to those described, can be used in the practice or testing of the embodiments. All publications mentioned are incorporated by reference for the purpose of describing and disclosing, for example, the designs and methodologies that are described in the publications which might be used in connection with the presently described embodiments. The publications listed or discussed above, below and throughout the text are provided solely for their disclosure prior to the filing date of the present disclosure. Nothing herein is to be construed as an admission that the inventors are not entitled to antedate such disclosure by virtue of prior publications.

In general, various embodiments of the present disclosure are related to a method and system for presenting panoramic surround view on a display in a vehicle. Furthermore, the embodiments in the present disclosure are related to a method and system for presenting panoramic surround view on a display in a vehicle such that a continuous surround display provides substantially maximum visibility with natural and prioritized view which minimizes blind spots.

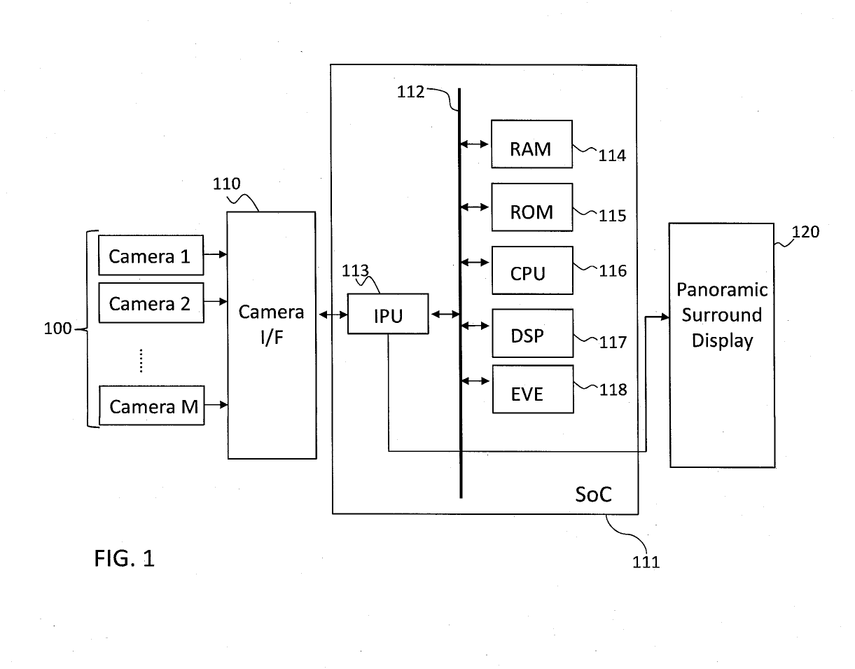

FIG. 1 is a block diagram of a panoramic surround display system in a vehicle that executes a method for presenting panoramic surround view on a display in the vehicle according to one embodiment. Note that the block diagram in FIG. 1 is merely an example according to one embodiment for an illustration purpose and not intended to represent any one particular architectural arrangement. The various embodiments can be applied to other types of vehicle display system implemented as long as the vehicle display system can accommodate panoramic surround view. For example, the panoramic surround display system of FIG. 1 includes a plurality of cameras 100, including Camera 1, Camera 2 . . . and Camera M where M is a natural number, each of which is able to record a series of images. A camera interface 110 receives the series of images as data streams from the plurality of cameras 100 and processes the series of images appropriate for stitching. For example, the processing may include receiving the series of images as data streams from the plurality of cameras 100 and converting serial data of data streams into parallel data for future processing. The converted parallel data from the plurality of cameras 100 is output from the camera interface 110 to a System on Chip (SoC) 111 for creating an actual panoramic surround view. The SoC 111 includes several processing units within the chip. An image processor unit (IPU) 113 which handles video input/output processing, a central processor unit (CPU) 116 for controlling high level operations of the panoramic surround view creation process such as application control and decision making, one or more digital signal processors (DSP) 117 which handles intermediate level processing such as object identification, and one or more embedded vision engines (EVEs) 118 dedicated for compute vision which handles low level processing at pixel level from cameras. Random access memory (RAM) 114 may be at least one of external memory, or internal on-chip memory, including frame buffer memory for temporally storing data such as current video frame related data for efficient handling in accordance with this disclosure and storing a processing result. Read only memory (ROM) 115 is for storing various control programs, such as a panoramic view control program and embedded software library, necessary for image processing at multiple levels of this disclosure. A system bus 112 connects various components described above in the SoC 111. Once the processing is completed by the SoC 111, the SoC 111 transmits the processing result video signal from video output of IPU 113 to a panoramic surround display 120.

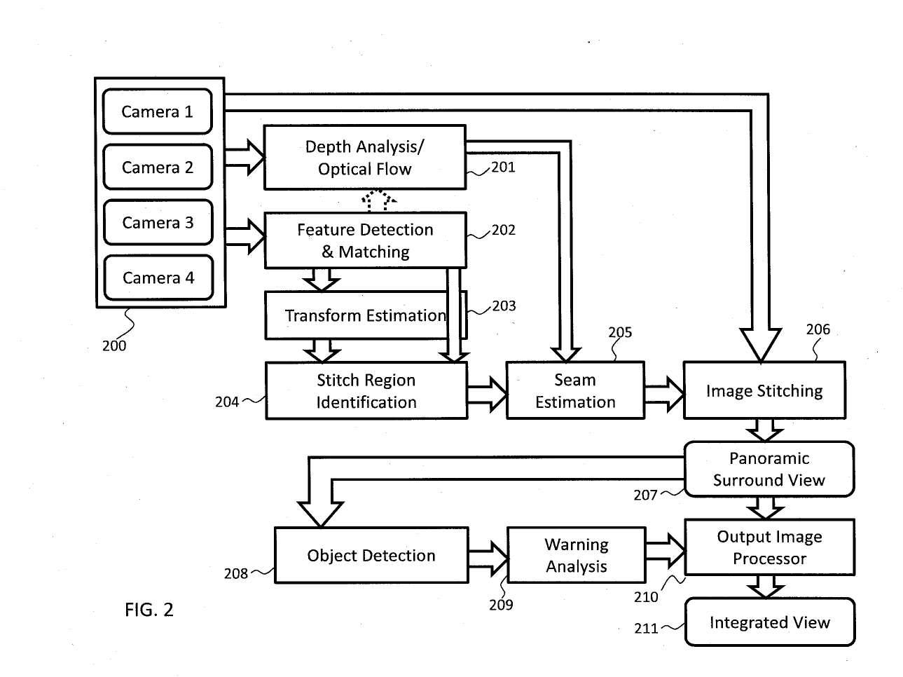

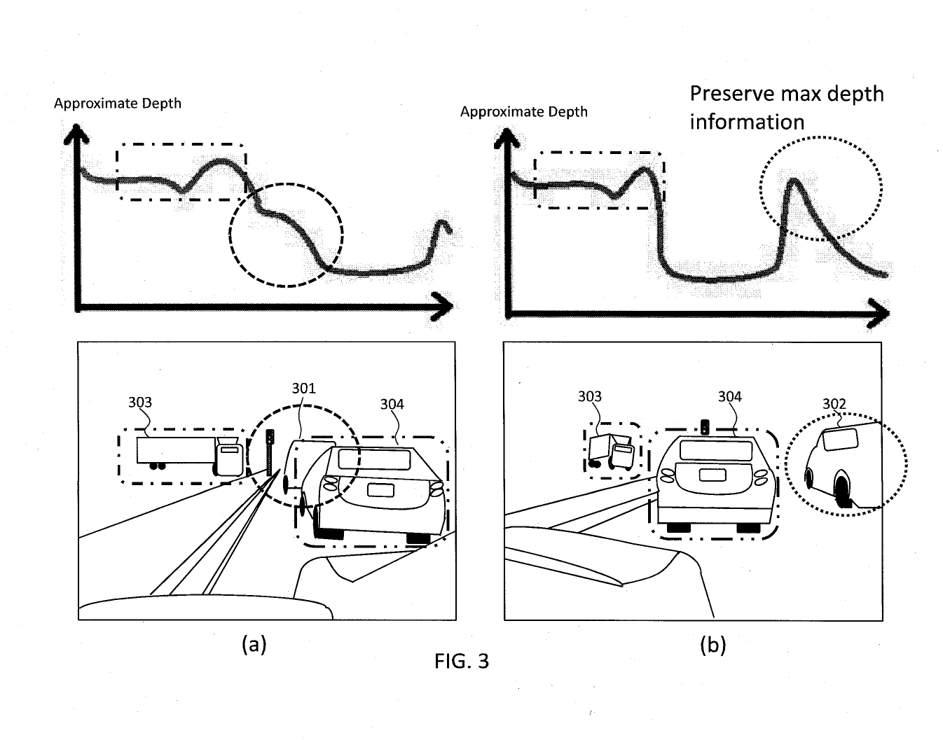

FIG. 2 is a system block diagram indicating data flow of a panoramic surround display system in a vehicle that executes a method for presenting panoramic surround view on a display in the vehicle according to one embodiment. Images are received originally from the plurality of cameras 200 via the camera interface 110 of FIG. 1 and captured and synchronized by the IPU 113 of FIG. 1. After the synchronization, a depth of view in regions in each image is estimated at a depth analysis/optical flow processing module 201. This depth analysis is conducted using optical flow processing typically executed at the EVEs 118 of FIG. 1. Optical flow is defined as an apparent motion of brightness patterns in an image. The optical flow is not always equal to the motion field, however, it can be considered substantially the same as the motion field as long as a lighting environment does not change significantly. The optical flow processing is one of motion estimation techniques which directly recover image motion at each pixel from spatio-temporal image brightness variations. Assuming that brightness of a region of interest is substantially the same between consecutive frames and points in an image move relatively small distance in the same direction of their neighbors, optical flow estimation can be executed as estimation of the apparent motion field between two subsequent frames. Further, when the vehicle is moving, the apparent relative motion of several stationary objects against a background may give clues about their relative distance in a manner that objects nearby pass quickly whereas objects in a long distance appear stationary. If information about the direction and velocity of movement of the vehicle is provided, motion parallax can be associated with absolute depth information. Thus, the optical flow representing the apparent motion may be translated into a depth, assuming that objects are moving at substantially the same speed. Optical flow algorithms such as TV-L1, Lucas-Kanade, Farneback, etc. may be employed either in a dense manner or in a sparse manner for this optical flow processing. Sparse optical flows provide feature-wise depth information whereas dense optical flows provide fine depth information using pixel level information. As a result of the depth analysis, the regions with substantially low average optical flow with substantially small detected motion is determined to be of substantially maximal depth, whereas the regions with higher optical flow are determined to be of less depth and thus the objects in the image are closer. The reasoning behind the above is that farther objects moving at the same velocity as closer objects tend to appear to move less in the image and thus optical flows of the farther objects tend to be smaller. For example, in FIGS. 3 (a) and (b), a depth of a vehicle A 301 is smaller than a depth of a vehicle B 302 driving in the same speed and the same direction of the vehicle A 301, because the vehicle A 301 is farther than the vehicle B 302.

In addition, a feature detection and matching module 202 conducts feature detection for each image after the synchronization. Feature detection is a technique to identify a kind of feature at a specific location in an image, such as an interesting point or edge. Invariant features are preferred to be used since they are robust for scale, translational and rotational variations which may be the case for vehicle cameras. Standard feature detectors may include Oriented FAST and Rotated BRIEF (Orb), Scale Invariant Feature Transform (SIFT), Speeded Up Robust Features (SURF), etc.

After feature detection, feature matching is executed. Any feature matching algorithm for finding approximate nearest neighbors can be employed for this process. Additionally, after feature detection, the detected features may be also provided to the depth analysis/optical flow processing module 201 in order to process the optical flow sparsely using the detected invariant features which increase efficiency of the optical flow calculation.

After feature matching, matched features can be used for estimation of image homography in a transform estimation process conducted by a transform estimation module 203. For example, transform between images from a plurality of cameras, namely homography, can be estimated. In one embodiment, random sample consensus (RANSAC) may be employed, however, any algorithm which provides homography estimate would be sufficient for this purpose.

The results of the transform estimation process are received at a stitch region identification module 204 as input. The stitch region identification module 204 determines a valid region of stitching within the original images by using the estimated transform from the transform estimation module 203 and by using the feature associations of detected features from the feature detection and matching module 202. Using the feature associations or matches from the feature detection and matching module 202, similar or substantially the same features across a plurality of images of the same and possibly neighboring timestamps are then identified based on attributes of the features. Based on the depth information, object types, relative position of each object in original images, and priority information is assigned to each feature.

Once the stitching regions are defined and identified, seam estimation process is executed in order to seek substantially the best points or lines where stitching is to be performed inside the stitching regions. A seam estimation module 205 receives output from the depth analysis module 201 and output from the stitch region identification module 204. The seam estimation module 205 computes an optimal stitching line, namely seam, that preserves a maximum number of priority features.

In one embodiment, as shown in FIGS. 3 (a) and (b), a vehicle A 301, a vehicle B 302, and a vehicle C 303, each having a relatively large approximate depth, are supposed to be relatively far. However, in this scenario, the vehicle A 301 and the vehicle B 302 are likely to keep substantially the same approximate depth after a short period of time whereas the vehicle C 303 approaching to the vehicle of observing the panoramic surround view is likely to have a smaller approximate depth after approach. Thus, if one possible risk is a vehicle approaching, it is possible to assign higher priority to the vehicle C 303 with a rapid change of its approximate depth and size of the region. Alternatively, an object hidden in one frame but appearing in its neighbor frame from a neighbor camera simultaneously should be preserved to eliminate blind spots. This can be obtained by feature matching with optical flow, and as a result, the vehicle A 301 and the vehicle B 302, having approximate depth appearing in one image while being absent in the other image between the two cameras are given priority for preservation. It is also possible to give risk priority to a vehicle D 304 which has a substantially low approximate depth with a larger size of its region because it is an immediate danger to the vehicle. The above prioritization strategies for defining the optimal stitching line are merely examples and any other strategy or combination of the above strategies and others may be possible.

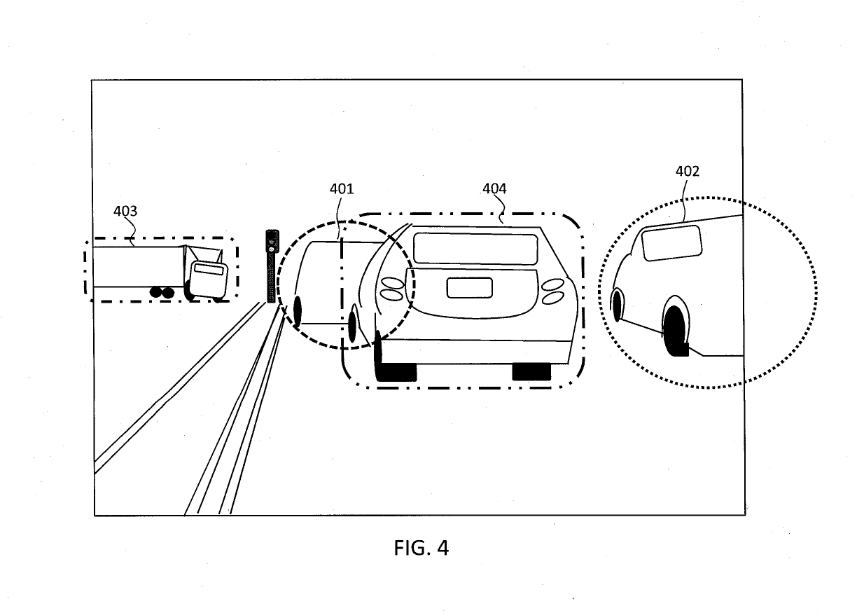

Once the optimal stitching line is determined by the seam estimation module 205, the images as output of the plurality of cameras 200 can be stitched by an image stitching module 206, using the determined optimal stitching line. Image stitching process can be embodied as the image stitching module 206 which executes a standard image stitching pipeline method of image alignment and stitching, such as blending based on the determined stitching line. As the image stitching process is conducted, a panoramic surround view 207 is generated. For example, after prioritization with the above strategies earlier described, the synthesized image in FIG. 4 includes the vehicle A 401, the vehicle B 402, the vehicle C 403 and the vehicle D 404.

In order to provide a more driver friendly panoramic surround view, some drive assisting functionality can be implemented over the panoramic surround view 207. In one embodiment, it is possible to identify an object of interest in the panoramic surround view and to alert the object of concern to the driver. An object detection module 208 takes the panoramic surround view 207 as input for further processing. In the object detection process, Haar-like features or histogram of oriented gradients (HOG) features can be used as feature representation and object classification by training algorithms such as AdaBoost or support vector machine (SVM) can be performed. Using the results of object detection, a warning analysis module 209 analyzes a distance to the object of interest, current velocity, acceleration and projected trajectory of the vehicle. Based on the analysis, the warning analysis module 209 determines whether the vehicle is in danger of an accident, such as recognizing the object of interest as an obstacle close to the vehicle, approaching to the vehicle, or being in a blind spot in the vehicle.

If it is determined that the object of interest is of a high risk for a potential accident of the vehicle, the object may be indicated on the panoramic surround view 207 with highlight. An output image processor 210 provides post-processing of images in order to improve quality of the images and to display warning system output in a human readable format. Standard image post-processing techniques, such as blurring and smoothing, as well as histogram equalization, in order to improve the image quality may be employed. All these image improvement, warning system output, and the highlighted object of interest can be integrated to an integrated view 211 as the system's final output to the panoramic surround display and presented to the driver.

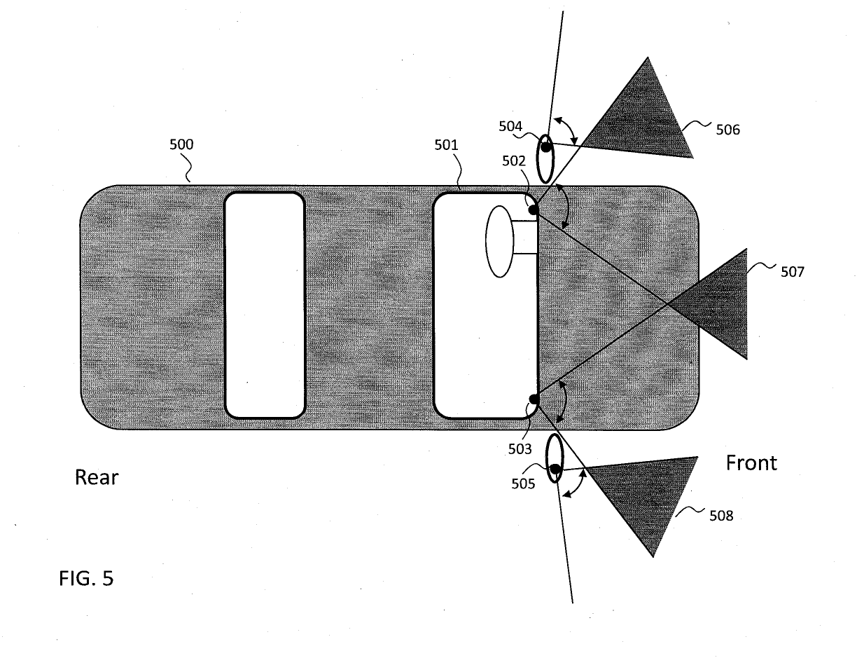

FIG. 5 illustrates a first typical camera arrangement around the vehicle, including cameras arranged at a plurality of locations around a front windshield 501 of a vehicle 500 and cameras arranged at side mirrors, according to one embodiment. For example, a front left camera 502 and a front right camera 503 are located at left and right sides of the front windshield 501 and a side left camera 504 and a side right camera 505 are located at left and right sides of the left and right side mirrors respectively, as illustrated in FIG. 5. In order to stitch images into a seamless panoramic view in order to eliminate blind spots, it is desirable that there are some overlap regions 506, 507, and 508 between two cameras among the plurality of cameras arranged around the vehicle 500 as illustrated. This arrangement can provide 180-degree forward-facing horizontal panoramic view or wider, depending on angles of view of the side left camera 504 and the side right camera 505. When a common area captured in two images is larger, more keypoints in the common area in the two images can be matched together, and thus the more accurately stitching lines can be computed. From our experiment, higher percentage of camera overlap, such as approximately 40%, resulted in obtaining a very accurate stitching line and the moderate percentage of camera overlap, such as approximately 20-30%, still resulted in obtaining a reasonably accurate stitching line.

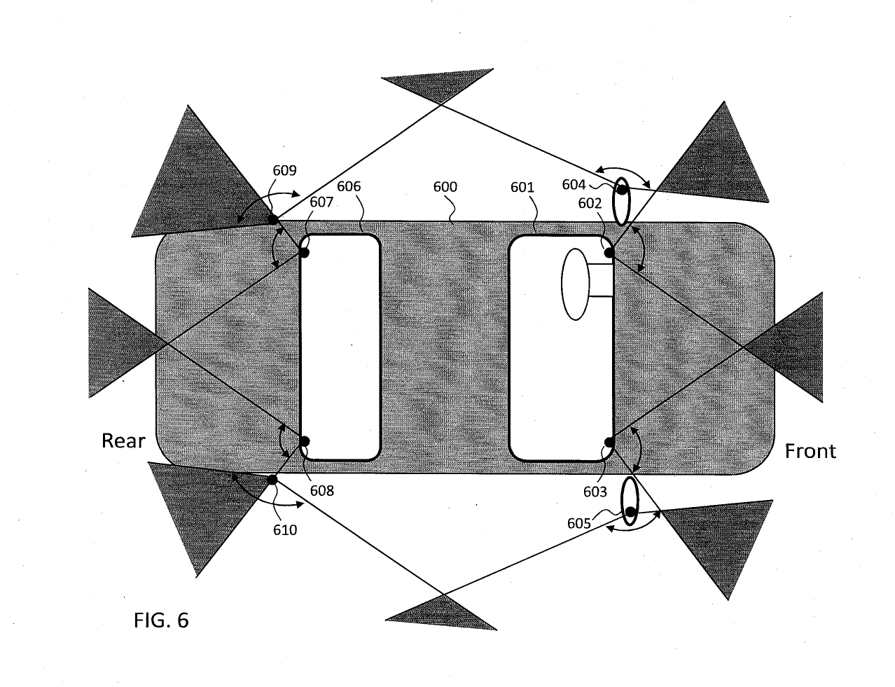

FIG. 6 illustrates a second typical camera arrangement around the vehicle including cameras arranged at a plurality of locations around a front windshield 601 of the vehicle 600, cameras arranged at side mirrors, cameras arranged at a plurality of locations around a rear windshield 606 of the vehicle 600 and cameras arranged at rear side areas of the vehicle, according to another embodiment. For example, a front left camera 602 and a front right camera 603 are located at left and right sides of the front windshield 601 and a side left camera 604 and a side right camera 605 are located at left and right sides of the left and right side mirrors respectively in FIG. 6, as similarly described above and illustrated in FIG. 5. Furthermore, a rear left camera 607 and a rear right camera 608 are located at left and right sides of the rear windshield 606 and a side left camera 604 and a side right camera 605 are located at left and right sides of the left and right side mirrors respectively in FIG. 6. This arrangement may provide a 360-degree full surround view, depending on angles of view of the side left cameras 604 and 609 and the side right cameras 605 and 610.

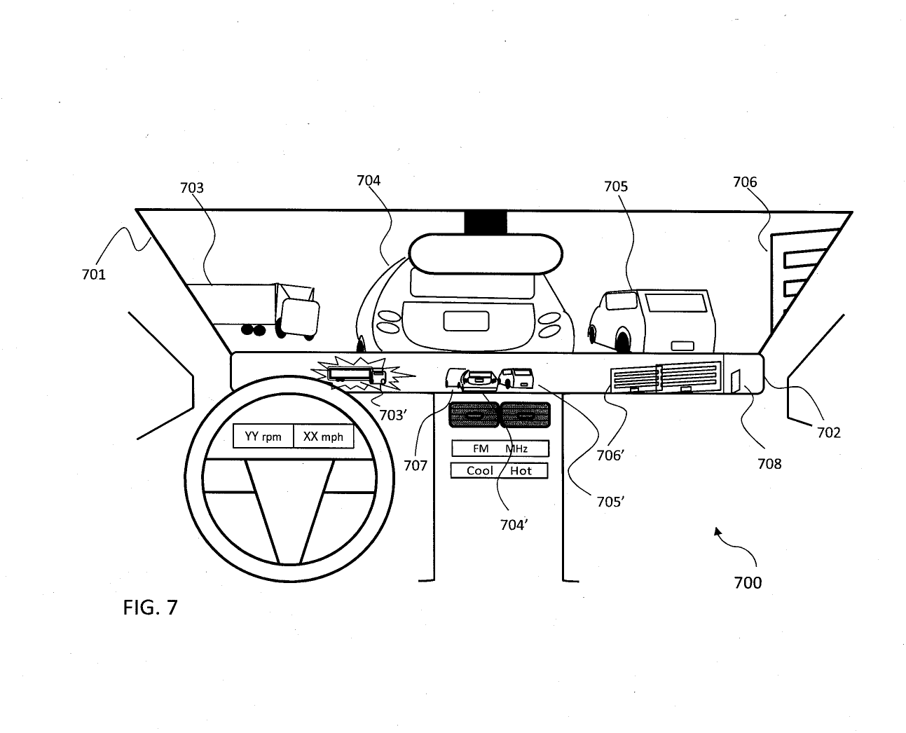

FIG. 7 shows an example of a front view through a front windshield 701 and an expected panoramic surround view on a panoramic surround display 702 above a dashboard from a driver seat in the vehicle 700, according to one embodiment. For example, as shown in the screen sample of FIG. 7, a truck 703, a hatchback car 704 in front, another car 705 and a building 706 are included in a view through the front windshield 701, and their corresponding objects 703′, 704′, 705′ and 706′ are displayed on the panoramic surround display 702 respectively. However, a vehicle-like object 707 and a building-like object 708 can be additionally seen on the panoramic surround display 702 as a result of stitching while eliminating blind spots. Thus, it is possible for a driver to recognize that there is another vehicle which corresponds to the vehicle-like object 707 in the front left direction of the preceding vehicle 704. Furthermore, an edge of the object 703′ may be highlighted in order to indicate that the object 703 is approaching in a relatively fast speed and of high risk regarding any potential accident. In this manner, the driver can be alerted of vehicles in blind spots and vehicles of dangerous behaviors in proximity.

In FIG. 7, one embodiment with a panoramic surround display between the front windshield and the dashboard is illustrated. However, it is possible to implement another embodiment, where the panoramic surround view can be displayed on the front windshield using a head-up display (HUD). By using the HUD, it is not necessary to install a panoramic surround display which may be difficult for some vehicle due to space restriction around the front windshield and dashboard.

Although this invention has been disclosed in the context of certain preferred embodiments and examples, it will be understood by those skilled in the art that the inventions extend beyond the specifically disclosed embodiments to other alternative embodiments and/or uses of the inventions and obvious modifications and equivalents thereof. In addition, other modifications which are within the scope of this invention will be readily apparent to those of skill in the art based on this disclosure. It is also contemplated that various combination or sub-combination of the specific features and aspects of the embodiments may be made and still fall within the scope of the inventions. It should be understood that various features and aspects of the disclosed embodiments can be combined with or substituted for one another in order to form varying mode of the disclosed invention. Thus, it is intended that the scope of at least some of the present invention herein disclosed should not be limited by the particular disclosed embodiments described above.

1. A method of presenting a view to an occupant in a vehicle, the method comprising:
capturing a plurality of frames by a plurality of cameras for a period of time;
detecting invariant features in image regions in consecutive frames of the plurality of frames;
matching the invariant features between the consecutive frames of the plurality of cameras to obtain feature associations;
estimating at least one transform based on the matched features of the plurality of cameras;
identifying a stitching region based on the detected invariant features, the feature associations and the estimated transform;
estimating an optical flow from the consecutive frames captured by the plurality of cameras for the period of time;
translating the optical flow into a depth of an image region in consecutive frames of the plurality of cameras;
estimating a seam in the identified stitching region based on the depth information;
stitching the plurality of frames using the estimated seam; and
presenting the stitched frames as the view to the occupants in the vehicle.

2. The method of presenting the view of claim 1,
wherein the estimation of the optical flow is executed densely in order to obtain fine depth information using pixel level information.

3. The method of presenting the view of claim 1,
wherein the estimation of the optical flow is executed sparsely in order to obtain feature-wise depth information using features.

4. The method of presenting the view of claim 3,
wherein the features are the detected invariant features.

5. The method of presenting the view of claim 1, the method further comprising:
assigning object types, relative position of each object in original images, and priority information to each feature based on the depth information
wherein the estimated seam is computed in a manner to preserve a maximum number of priority features in the view.

6. The method of presenting the view of claim 5, the method further comprising:
assigning higher priority, to an object with a relatively larger region.

7. The method of presenting the view of claim 5, the method further comprising:
assigning higher priority to an object with a rapid change of its approximate depth and size of the region indicative of approaching to the vehicle.

8. The method of presenting the view to the occupant in the vehicle of claim 5, the method further comprising:
assigning higher priority to an object appearing in a first image captured by a first camera but not appearing in a second image captured by a second camera located next to the first camera.

9. The method of presenting the view of claim 1, the method further comprising:
identifying an object of interest;
analyzing a distance to the object of interest, current velocity, acceleration and projected trajectory of the vehicle;
determining whether the vehicle is in danger of an accident by recognizing the object of interest as an obstacle close to the vehicle, approaching to the vehicle, or being in a blind spot in the vehicle; and
highlighting the object of interest in the view if it is determined that the object of interest is of a high risk for a potential accident of the vehicle.

10. A panoramic surround view display system comprising:
a plurality of cameras configured to capture a plurality of frames for a period of time;
a non-transitory computer readable medium configured to store computer executable programmed modules and information;
at least one processor communicatively coupled with the non-transitory computer readable medium configured to obtain information and to execute the programmed modules stored therein,
wherein the programmed modules comprise:
a feature detection and matching module configured detect features in image regions in consecutive frames of the plurality of frames and to match the features between the consecutive frames of the plurality of cameras to obtain feature associations;
a transform estimation module configured to estimate at least one transform based on the matched features of the plurality of cameras;
a stitch region identification module configured to identify a stitching region based on the detected features, the feature associations and the estimated transform;
a seam estimation module configured to estimate a seam in the identified stitching region;
an image stitching module configured to stitch the plurality of frames using the estimated seam; and
an output image processor configured to process the stitched frames as the view to the occupants in the vehicle;
wherein the programmed modules further comprise:
a depth analyzer configured to estimate an optical flow from the plurality of frames by the plurality of cameras for the period of time;
and to translate the optical flow into a depth of an image region in consecutive frames of the plurality of cameras;
wherein the seam estimation module is configured to estimate the seam in the identified stitching region based on the depth information.

11. The panoramic surround view display system of claim 10,
wherein the depth analyzer is further configured to estimate the optical flow densely in order to obtain fine depth information using pixel level information.

12. The panoramic surround view display system of claim 10,
wherein the depth analyzer is further configured to estimate the optical flow sparsely in order to obtain feature-wise depth information using features.

13. The panoramic surround view display system of claim 12,
wherein the features are the detected invariant features.

14. The panoramic surround view display system of claim 10,
wherein the stitch region identification module is configured to assign object types, relative position of each object in original images, and priority information to each feature based on the depth information; and
wherein the seam estimation module is configured to compute the seam in order to preserve a maximum number of priority features in the view.

15. The panoramic surround view display system of claim 14,
wherein the stitch region identification module is further configured to assign higher priority to an object with a relatively larger region.

16. The panoramic surround view display system of claim 14,
wherein the stitch region identification module is further configured to assign higher priority to an object with a rapid change of its approximate depth and size of the region indicative of approaching to the vehicle.

17. The panoramic surround view display system of claim 14,
wherein the stitch region identification module is further configured to assign higher priority to an object appearing in a first image captured by a first camera but not appearing in a second image captured by a second camera located next to the first camera.

18. The panoramic surround view display system of claim 10,
wherein the programmed modules further comprises:
an object detection module configured to identify an object of interest in the view; and
a warning analysis module configured to analyze a distance to the object of interest, current velocity, acceleration and projected trajectory of the vehicle and to determines whether the vehicle is in danger of an accident by recognizing the object of interest as an obstacle close to the vehicle, approaching to the vehicle, or being in a blind spot in the vehicle; and
wherein the output image processor is further configured to highlight the object of interest in the view if it is determined that the object of interest is of a high risk for a potential accident of the vehicle.

19. The panoramic surround view display system of claim 10,
wherein the system further comprises a panoramic surround display between the front windshield and the dashboard, configured to display the view from the output image processor.

20. The panoramic surround view display system of claim 10,
wherein the system is coupled to a head up display configured to display the view from the output image processor.
